(19) United States
(12) Patent Application Publication
(10) Pub. No.: US 2025/0214784 A1
(43) Pub. Date: Jul. 3, 2025

(54) Apparatus for Manufacturing Modules or Precursors of Modules

(71) Applicant: MB Automation GmbH & Co. KG, Roding (DE)

(72) Inventor: Dmitry Busov, Geiselhoering (DE)

(21) Appl. No.: 18/853,761

(22) PCT Filed: May 24, 2023
(86) PCT No.: PCT/EP2023/063892

§ 371 Date: Oct. 3, 2024

(30) Foreign Application Priority Data
Jun. 17, 2022 (DE) 10 2022 115 207.3

(51) Int. Cl. B65G 47/244; H01M 8/0297; H01M 10/04

(52) U.S. Cl. CPC B65G 47/244; H01M 8/0297; H01M 10/0404; B65G 2201/022

(57) ABSTRACT

A method and an apparatus for the production of modules or precursors of modules, in particular of fuel or battery cells containing layer material. The method includes conveying individual anode layers to a first transfer location for transfer to a first layer turner; conveying individual cathode layers to a second transfer location for transfer to a second layer turner; turning picked-up anode or cathode layers by a respective angle of rotation to a respective first or second delivery location; reciprocating the anode or cathode layers by a respective angle of rotation to a respective first or second delivery location; and transferring the anode or cathode layers to respective first or second layer turners at the respective first and second delivery locations.

### CROSS-REFERENCE TO RELATED APPLICATIONS

This application is a National Stage application of International Application No. PCT/EP2023/063892 filed May 24, 2023, which claims priority to German Patent Application Serial No. DE 102022115207.3 filed Jun. 17, 2022.

### BACKGROUND

An apparatus and a method for manufacturing modules or precursors of modules are disclosed herein. These modules or precursors of modules can be fuel cells or battery cells containing layer material. Details of this are defined in the claims. The description also contains relevant information on the structure and mode of operation as well as on variations at of the apparatus and the process.

### DISCUSSION OF THE RELATED ART

WO 2021 171 946 A1 relates to a stacking table on which laminate stacks of release films and electrode layer are stacked. A transport unit is used to transport the release films and electrode layer and to place them on the stacking table. The above testing device checks the position of the electrode layer in the laminate stacks released by the transport unit.

JP 2014 078464 A relates to a laminating machine for producing a laminated body of a rectangular film as a positive electrode, a rectangular film as a negative electrode, which are alternately laminated via a rectangular separating film. A conveyor is used to successively pick up and convey the cathode foil, the anode foil and the separating foil to a predetermined stacking position and to align and stack the cathode foil, the anode foil and the separating foil at the stacking position. Four first holding elements are arranged at the four corners of the laminated body to be stacked at the stacking position and serve to press from above the four corners of the cathode foil transported from the conveyor to the stacking position and placed there or the four corners of the separating foil transported from the conveyor to the stacking position and placed there in order to stack them under the cathode foil. First horizontal shifting means can shift the position of the first holding elements in the horizontal direction from a retracted position at least outside the cathode foil or the release foil to a holding position corresponding to the four corners of the cathode foil or the release foil. A first means for displacement in the vertical direction serves to displace the position of the first holding element in the vertical direction from a released position, which is separated at least upwards from the cathode foil or the separating foil, to a contact position which is able to touch the cathode foil or the separating foil. Four second holding elements are provided at the four corners of the laminated body to be stacked at the stacking position to press from above the four corners of the negative electrode foil located at the stacking position or the four corners of the release foil located at the stacking position to be stacked under the negative electrode foil. Second horizontal displacement devices are used to shift the position of the two holding elements in the horizontal direction from a retracted position at least outside the anode foil or the separating foil to a holding position corresponding to the four corners of the anode foil or the separating foil. The second displacement devices for displacement in the vertical direction serve to displace the position of the second holding element in the vertical direction from a position that is separated at least upwards from the anode foil or the separating foil to a contact position in which the second holding element touches the anode foil or the separating foil. When a new cathode foil, anode foil or separating foil is conveyed and brought into the stacking position, the newly placed cathode foil, anode foil or separating foil is held down and the four corners of the cathode foil, anode foil or separating foil already placed underneath are held down. After the four first or second holding elements have been pulled out, the four corners of the newly placed cathode foil, anode foil or separating foil are held down by the corresponding four first or second holding elements. The four corners of the newly placed cathode foil, anode foil or separator are pressed by four corresponding first or second holding elements. The height of the first and second holding elements when they move from the holding position to the holding position is set so that it is higher than the height of the first and second holding elements when they return from the holding position to the retraction position. When holding down the cathode foil, the anode foil or the separating foil during the movement from the holding position to the retraction position, the stroke paths of the holding elements are higher than the stroke paths during the movement from the holding position to the retraction position.

WO 2021 171 946 A1 relates to a testing device for testing the position of the electrode layer in a laminate, in which a release film and an electrode layer are bonded by an adhesive substance, from the release film side. An infrared emitter illuminates the laminate with infrared light from the release film side. A camera sensitive to infrared light records the in infrared light transmitted through the release film and reflected by the electrode layer. A detection unit detects the position of the electrode layer on the base layer of the image recorded by the camera.

In addition, in the prior art, the movable means is moved horizontally to contact the electrode plate on one surface of the separator, and then the movable means rotates to move the other surface of the separator to the cell stack attached to the side of the attachment means, periodically during the process. The tension of the separator is variable. Therefore, manufacturing may become less efficient because the separator film may tear at the time the separator film is pulled taut during the process. As a result, the electrode plate cannot be stacked at the exact position of the separating membrane at the time when the separating film is loosened during the process. The consistent quality of the cell stack poses a problem that is difficult to solve.

WO 2020 130 184 A1 describes the production of a cell stack of a secondary battery. A stacking table can be moved back and forth. A separator feed unit is positioned on the stacking table and feeds a separator to the stacking table. A first multiple head is provided on one side of the stacking table and stacks one layer after the other by placing the electrode layers on the stacking table, which is moved to one side. A second multiple head is provided on the other side of the lamination table and stacks the electrode layers on the stacking table, which is moved to the other side.

Based on this situation, a cost-effective and robust arrangement of a stacking unit and a procedure for stacking layer material with high processing speed is to be provided in order to manufacture modules or precursors of modules, for example fuel cells or battery cells containing layer material, with high precision.

### SUMMARY

An apparatus is used for the production of modules or pre-stages of modules, in particular of fuel or battery cells containing layer material. In this device, a first conveyor is provided and adapted to convey individual anode layers to a first transfer location for transfer to a first layer turner. A second conveyor is provided and adapted to convey individual cathode layers to a second transfer location for transfer to a second layer turner. The first and second layer turners each have at least one pick-up. Each layer turner has a first drive. The first and second layer turners are provided and adapted to pick up a respective one individual anode or cathode layer from the first or second conveyor by means of their pick-ups at the respective first or second transfer location and to rotate it by means of the first drive through a respective angle of rotation to a respective first or second delivery location. A stacking table with a drive is provided for this purpose and is set up to move back and forth between the first and second delivery locations. The first and second layer turners are provided and adapted to deliver an anode or cathode layer from their pick-up to the stacking table at the first and second delivery locations, respectively, when the pick-up—and the stacking table—are located at the first and second delivery locations, respectively. The first and second layer turners each have a second drive for each of the pick-ups. These are provided for this purpose and are set up to retract the respective pick-up radially when it approaches the pick-up of the other layer turner. This enables the apparatus to very quickly build up a stack of electrodes from the alternately stacked individual anode or cathode layers on the stacking table. In a variant, the first and second drives are independent of each other and rotate the first and second layer turners or move the pick-ups according to a predetermined radial profile along a rotation angle of the layer turners.

The back-and-forth movement of the stacking table between the first and second delivery locations limits the number of anode or cathode layers to be deposited per time unit. The solution presented here of radially retracting the respective pick-up(s) of one layer turner when approaching the pick-up(s) of the other layer turner, especially in the space between the layer turners, allows a smaller distance between the first and second delivery location than with a circular trajectory of the pick-ups of both layer turners, which must not touch each other. This means that the length of the travel path of the stacking table between the two delivery locations can be reduced. This is particularly relevant after the pick-up(s) have placed the anode or cathode layers on the stacking table deposit (6 o'clock position in FIG. 1), and the empty pick-ups enter the space between the two layer turners. Without this radial retraction of the pickups, their trajectories would be significantly larger, which would result in an increased distance between the first and the second delivery locations. This also enables a more compact design of the entire range system. Overall, in a variant, the pick-ups of the two layer turners each move along an approximated, upright ellipse whose (vertical) main axes extend from the center of the respective transfer location to the center of the respective delivery location and whose (horizontal) secondary axes do not touch each other. Guiding the pick-ups along these approximately elliptical paths avoids a collision of the pick-ups when turning from the delivery location back to the transfer location, even though the two layer turners are arranged close to each other in order to keep the path of the stacking table from one layer turner to the other layer turner as short as possible.

In a variant of the apparatus, the first and second layer turners are provided For this purpose and set up to move the pick-ups out by means of their respective second drive when the pick-ups approach the respective first or second transfer location and/or the first or second delivery location. To pick up the anode or cathode layers at the respective transfer locations (12 o'clock position or 6 o'clock in FIG. 1), the pick-ups of the two layer turners can be extended radially. The radial movement of the pick-ups begins before the pick-ups reach the 6 or 12 o'clock position and not only when they reach this position.

This increases the location accuracy of the pick-up of the anode or cathode layers from the two conveyors at the respective transfer locations. This allows a higher number of anode or cathode layers per time unit to be deposited on the stacking table without compromising the accuracy of the electrode stack build-up. With this device, a layer can be deposited in around 130 ms or less.

In a variant of the apparatus, an endless separator is fed from above into the space between the two layer turners, which is folded into a Z-shape on the stacking table. The stacking table constantly moves horizontally back and forth between the two depositing positions, so that for a stack of electrodes, starting with the separator and then alternately the anode and cathode layers, always separated by the folded separator, are deposited alternately by the two layer turners on the stacking table.

In a variant of the apparatus, the first conveyor and the second conveyor are neighboring and arranged at a distance from each other. In a variant of the apparatus, the first conveyor and/or the second conveyor are designed as belt conveyors, the respective underside of which faces the first or second layer turners in order to convey the individual anode layers or the individual cathode layers on their underside to the first or second transfer location.

In a variant of the apparatus, the first conveyor and/or the second conveyor each have a controlled under/overpressure conveyor belt. They are intended and set up to pick up the individual anode layers or the individual cathode layers by means of controlled pneumatic under-pressure and to hold them during conveying to the first or second transfer location. In a variant of the apparatus, a controlled pneumatic overpressure, for example in the form of a short blast, is used to release the anode layers or the individual cathode layers at the first or second transfer location to the first or second layer turner.

In a variant of the apparatus, the first and/or second layer turner each have several pick-ups for picking up the individual anode or cathode layers. The pick-ups are intended and set up to rotate past the respective transfer location and the respective delivery location in a continuous or clocked manner. The pick-ups of the first and/or second layer turner can pick up or release the respective individual anode or cathode layer.

The angle of rotation of the first and/or second layer turner is approximately 180°, for example. When a layer is picked up from the conveyor by the layer turner, turned and then placed on the stacking table, the layer is turned. This means that the free upper side of the layer lying off the conveyor before it is picked up by the pickers is the same free upper side of the layer after it has been placed on the stacking table, but with the orientation turned by the angle of rotation (for example 180°.) The first and second layer turners rotate around their respective centers of rotation.

In a variant of the apparatus, the first and second layer turners generally have a matching structure, matching function and/or matching dimensions. In a variant of the apparatus, the first and second layer turners are provided and adapted to rotate clockwise and anti-clockwise respectively by means of their respective first drive in such a way that the individual anode or cathode layers from their transfer location to their delivery location while avoiding a space between the first and second layer turner. In other words, the individual anode or cathode layers are conveyed from their transfer location to their delivery location “around the outside” of the first or second layer turners, and not between the two layer turners.

In a variant of the apparatus, the first and second transfer locations between the first conveyor or the second conveyor and the first or second layer turners each have a first center, and the first and second delivery locations each have a second center between the first or second layer turners and stacking table. In a variant of the apparatus, these respective first and second centers lie on a straight line that essentially at least approximately intersects a respective center of rotation of the first conveyor or the second conveyor.

In a variant of the apparatus, the stacking table has a deposit for the individual anode and cathode layers. In a variant of the apparatus, the stacking table has a single-axis or multi-axis positioning device, which is provided and adapted to move the deposit along or around the respective axis(es) in order to align it with the first or second delivery location. This allows a precise stacking of the layers on the deposit, which enables reliable production without large losses of mis-produced electrode stacks.

In a variant of the apparatus, the stacking table has at least one first and at least one second clamping finger, which are provided and designed to alternately or simultaneously engage or disengage with the uppermost of the anode and cathode layers and/or to press the uppermost of the anode and cathode layers against the electrode stack on the deposit. In a variant, the deposit can be rotated about a z-axis (vertical axis) with the clamping fingers. In a variant, the deposit can be positioned in the x and/or y direction using the clamping fingers.

In a variant of the apparatus, the first and second layer turners are provided and adapted to pick up the individual anode layers and the individual cathode layers by means of a controlled pneumatic under-pressure and to hold them during turning to the first and second delivery location respectively. In addition, or instead, the individual anode layers and the individual cathode layers are deposited at the first or second delivery location by means of a controlled pneumatic overpressure in order to stack the layers on the deposit.

In a variant of the apparatus, the first and second layer turners each have a rotatable over/under pressure distribution, which is intended and set up to feed the pick-ups with the controlled pneumatic under-pressure and/or over-pressure. In a variant of the apparatus, the first and second layer turners are provided and adapted to turn only one of the anode layers or only one of the cathode layers towards the first or second delivery location.

In a variant of the apparatus, each positioning device is provided and adapted to lower the deposit when stacking the individual anode layers and individual cathode layers by a distance that essentially corresponds to the thickness of an individual anode layer or an individual cathode layer.

In a variant of the apparatus, the first drive is designed as a rotary drive, which is intended and set up to turn the pick-up of the respective layer turning device. In a variant of the apparatus, the second drive has a rotary drive with an eccentric shaft coupled to the transducers in order to radially retract and/or extend the transducer of the respective layer turning device. Alternatively, the second drive has a linear drive that is geared to one of the transducers in order to radially retract and/or extend the transducers of the respective layer turner.

A method for manufacturing modules or precursor modules, in particular fuel or battery cells containing layer material, carried out for example with the apparatus described above, comprises the steps, for example in the following order: conveying individual anode layers to a first transfer location for transfer to a first layer turner; conveying individual cathode layers to a second transfer location for transfer to a second layer turner; picking up a respective one of the individual anode or cathode layers at the respective first or second transfer location by respective pickups of a respective first layer or second turner; turning the picked-up anode or cathode layers by a respective angle of rotation to a respective first or second delivery location; moving a stacking table with a drive back and forth between the first and the second delivery location; delivering the respective individual anode or cathode layer at the first or the second delivery location to the stacking table when the latter is at the first or the second delivery location; and radially retracting the pick-up of the first and/or second layer turner when it approaches the pick-up of the other layer turner.

This approaching of the pick-up of one layer turner towards the pick-up of the other layer turner is particularly relevant in the space between the two layer turners if the pick-up approaches a pick-up of the other layer turner on the way from its delivery location to its transfer location or from its transfer location to its delivery location.

Process aspects are shown above in device terms and vice versa. Both the process aspects and the apparatus terms serve to explain the apparatus and its operation.

### BRIEF DESCRIPTION OF THE DRAWINGS

Further features, properties and advantages of the apparatus and methods can be found in the following description in conjunction with the drawings. Possible variations will become clear to a person skilled in the art from the description given, in which reference is made to the accompanying drawings. The figures schematically show the apparatus discussed here and explain their operation. The same or analogous parts in the Fig. are not individually marked with reference signs. Hereinafter shows:

FIG. 1 a schematic front view of an apparatus for manufacturing modules or precursors of modules;

FIG. 2 schematic side view of one of the two layer turners of an apparatus for manufacturing modules or precursors of modules in a further variant; and

FIG. 3 a flow chart of a process that can also be carried out by the apparatus.

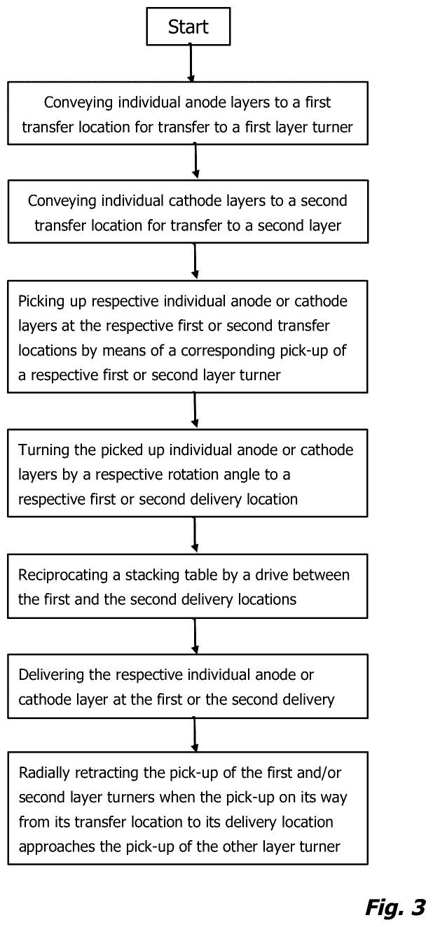

### DETAILED DESCRIPTION OF THE EMBODIMENTS

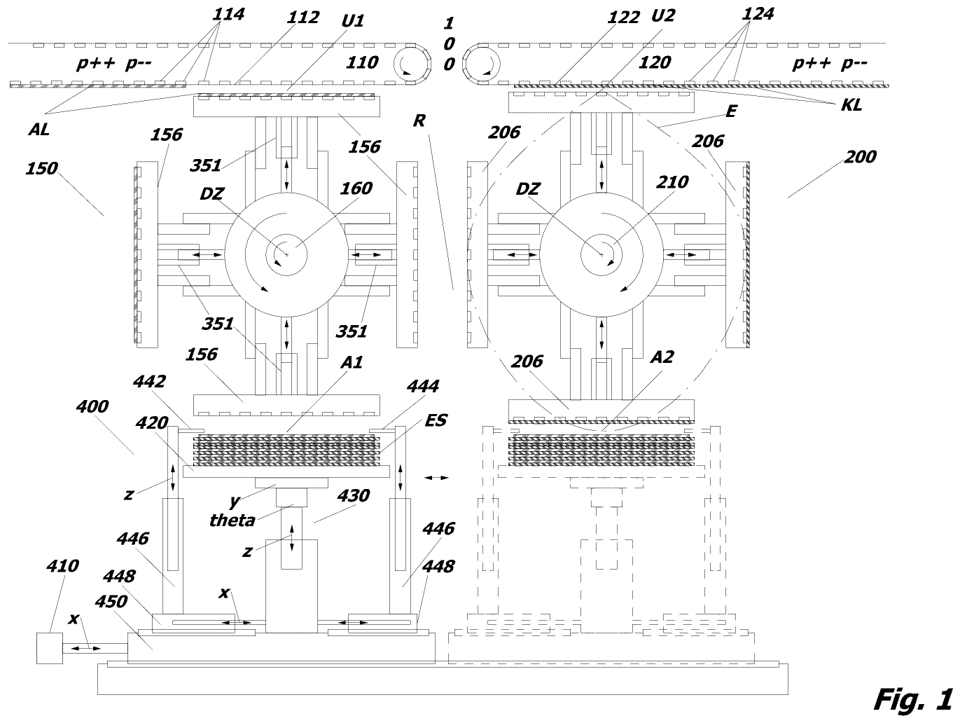

FIG. 1 schematically illustrates an apparatus 100 for manufacturing modules or precursors of modules. Here, the apparatus 100 is explained by way of example using the manufacture of fuel or battery cells containing layer material and/or fluid.

In the apparatus 100, a first conveyor 110 serves to convey individual anode layers AL to a first transfer location U1 for transfer to a first layer turner 150. A second conveyor 120 is used to convey individual cathode layers KL to a second transfer location U2 for transfer to a second layer turner 200.

As illustrated in FIG. 1, the first conveyor 110 and the second conveyor 120 are arranged in the upper area of the apparatus 100 at the same level, adjacent to and at a distance from a other. Here, the first conveyor 110 and the second conveyor 120 are designed as belt conveyors with their respective undersides 112, 122 facing the first or second layer turners 150, 200. Thus, the first conveyor 110 and the second conveyor 120 can convey the individual anode layers AL or the individual cathode layers KL on their underside 112, 122 to the first or the second transfer location U1, U2. In particular, the first conveyor 110 and the second conveyor 120 each have a controlled under-pressure/over-pressure conveyor belt with suction/blow openings 114, 124 in order to pick up the individual anode layers AL or the individual cathode layers KL by means of a controlled pneumatic vacuum p−− and hold them during conveying to the first or the two transfer locations U1, U2. The individual anode layers AL or the individual cathode layers KL can be delivered to the first or second transfer location U1, U2 to the first or second layer turners 150, 200 in a controlled manner by means of a pneumatically supplied over-pressure p++ at the suction/blowing openings 114, 124. The first conveyor 110 can take over the individual anode layers AL from a stack or a third conveyor (not shown), in particular a vacuum conveyor belt. The second conveyor 120 can take the individual cathode layers KL from a stack or a fourth conveyor (not shown), in particular a vacuum conveyor belt.

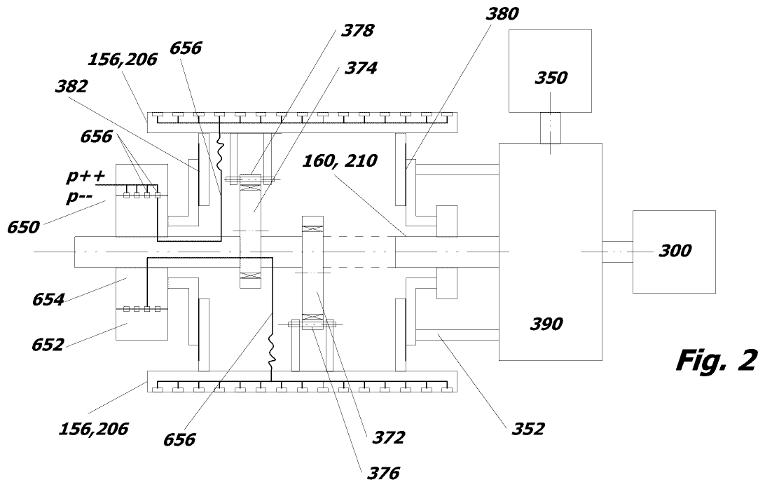

The first and second layer turners 150, 200 each have four approximately rectangular flat pick-ups 156, 206 and a first drive 300 (see FIG. 2). The pick-ups 156, 206 are used to pick up a respective one anode or cathode layer AL, KL at the respective first or second transfer location U1, U2 of the first or second conveyor 110, 120. These pick-ups 156, 206 are indirectly mounted for radial displacement on a rotatably mounted shaft 160, 210. This shaft 160, 210 rotates the respective pick-ups 156, 206 by means of the first drive 300 through a respective angle of rotation RW—here 180°—to a respective first or second delivery location A1, A2. The first drive 300 rotates the layer turners 150, 200 as a whole. The first and second layer turners 150, 200 with their respective multiple pick-ups are thus set up to pick up the individual anode or cathode layers AL, KL when the pick-ups rotate past the respective transfer location U1, U2 and the respective delivery location A1, A2 in a continuous or clocked manner and pick up or deliver the respective individual anode or cathode layer AL, KL. The first and second layer turners 150, 200 rotate by means of their respective first drive 300 clockwise or anti-clockwise so that the individual anode or cathode layers AL, KL pass from their transfer location U1, U2 to their delivery location A1, A2 avoiding the space R between the first and second layer turners 150, 200.

It is evident that the first and second layer turners 150, 200 essentially have a matching structure, matching function and/or matching measurements.

An endless separator belt, which is not illustrated in detail, is guided from above between the two conveyors 110, 120 into and through the space R and exits at the lower end of the space R from a gap between two rotatably mounted rollers. The separator belt is folded in a z-shape on the stacking table and the anode and cathode layers are separated by the separator from each other.

The first and second layer turners 150, 200 have (see FIG. 1) an arrangement of linear are drives 351 arranged on slewing rings as the second drive 350 for the pick-ups 156, 206, of which one linear drive 351 in each case is geared to one of the pick-ups 156, 206 in order to radially retract and/or extend the pick-ups of the respective layer turner 150, 200.

In a further variant, the first and second layer turners 150, 200 each have a second drive 350 (see FIG. 2) for the pick-ups 156, 206. This second drive 350 serves to retract the respective pick-up 156, 206 radially when—after depositing the respective layer on the stacking table 400—the pick-up of the layer turner on the way to its pick-up locations U1, U2 approaches in the space between the two layer turners. The second drive 350 rotates the tube, the turntable connected to it and the pick-ups 156, 206 around the center of rotation DZ. Due to the coupling to a cam described below, the pick-ups 156, 206 are moved radially. The first drive 300 is a controlled servo motor that rotates the layer turner as a whole in order to turn the pick-up about a center of rotation of the layer turner. In the variant illustrated in FIG. 2, the second drive 350 is a servo motor that can be controlled independently of the first rotary drive 300 and is geared to the inner shaft 160, 210, which is designed as an eccentric shaft. This eccentric shaft is provided with cams 372, 374 for each of the pick-ups in order to pull the pick-ups 156, 206 of each load generator shaft 150, 200 radially back to and extend them. For this purpose, each cam 372, 374 is surrounded by a needle bearing, which carries a ring 376, 378 on the outside, which is guided on the respective left pick-up 156, 206. When the shaft 160, 210 is rotated, the respective cam 372, 374 acts to move the transducers 156, 206, which are each guided in radially orientated linear guide runs 380, 382 outwards or inwards. In particular, a radial retraction of the pick-ups of the first and/or the second layer turner takes place when the pick-up approaches a pick-up of the layer turner on the way from its delivery location to its transfer location or from its transfer location to its delivery location.

The second drive 350 rotates the respective inner shaft 160, 210 and causes the transducers to extend and retract radially. In particular, the second drive 350 also serves to cause the first and second layer turners to extend the respective pick-ups radially when the pick-ups approach the respective first or second transfer location U1, U2 and the first or second delivery location A1, A2. Overall, in this variant the pick-ups of the two layer turners each move approximately on an approximated, upright ellipse, the main axes of which extend from the center of the respective transfer location to the center of the respective delivery location and the secondary axes of which do not touch each other. In FIG. 1, this ellipse E is shown as a dotted line on the second layer turner 200. This movement does not have to be symmetrical, as the pick-up lying away from the space R is extended further radially than the pick-up located in the space R.

The first drive 300 and the second drive 350 are brought together into rotation via a combined angular and axial gear 390 and independently of each other move the inner shaft 160, 210 or all the pick-ups of a layer turner as a whole via a connecting element, e.g. a tube 352. As illustrated in FIG. 2, the tube 352 and the shaft coupled to the first drive 300 have collinear axes of rotation.

A stacking table 400 for picking up the individual cell anode or cathode layers AL, KL at the respective first or second delivery location A1, A2 is provided with a drive 410. This drive 410 moves the stacking table 400 back and forth along the x-axis between the first and second delivery locations A1, A2 in a controlled manner, so that the stacking table 400 is precisely aligned with the anode or cathode layer AL, KL to be deposited on it. In FIG. 1, the stacking table is shown in its left aligned position under the layer turner 150 in solid lines, and in its right aligned position under the layer turner 200 in short dashed lines.

The first and second layer turners 150, 200 each deliver an individual anode or cathode layer AL, KL from their pick-up 156, 206—in the 6 o'clock position in FIG. 1—to the stacking table 400 at the first or second delivery location A1, A2 when the pick-up 156, 206 is located at the first or second delivery location A1, A2.

For this purpose, in the variant of the apparatus 100 illustrated here, the first and second transfer locations U1, U2 each have a first center (approximately above the center of the pick-up located in the 12 o'clock position between the pick-up and the conveyor), just as the first and second delivery locations A1, A2 each have a second center (approximately below half the center of the pick-up located in the 6 o'clock position between the pick-up and the stacking table). These respective first and second centers are located on an imaginary device that intersects a respective center of rotation DZ of the first layer turner 150 or the second layer turner 200. The first and second layer turners each turn only one of the anode layers AL and only one of the cathode layers KL towards the first and second delivery locations A1, A2 respectively.

In the arrangement with the eccentric drive, the first drive of a layer turner and the second drive of the same layer turner can rotate continuously in the same direction or even temporarily in opposite directions. This allows the rotary movement of the layer turner as a whole to be superimposed on the radial inward/outward movement of its pick-ups in such a way that a particularly short distance between the two layer turners, and thus a particularly short distance between the two delivery locations, is possible. In addition, the two layer turners (in both variants of FIGS. 1 and 2) can be rotated by their respective first drives in such a way that the pick-up(s) of one layer turner rotate in exactly the opposite phase to the pick-up(s) of the other layer turner. This means that in the case of one pick-up per layer turner, one pick-up of one layer turner is located near the transfer location, while one pick-up of the other layer turner is located near the delivery location. In the case of four pick-ups per layer turner, one pick-up of one layer turner precedes a pick-up of the other layer turner by approximately 45°.

The stacking table 400 has a deposit 420 for the anode and cathode layers AL, KL and a positioning device 430 with a corresponding rotary drive around the z-axis, which moves the deposit 420 along the axes and around the z-axis. In this way, the stacking table 400 and its deposit 420, or more precisely its center, can be aligned precisely to the first or two delivery locations A1, A2 and the pick-up in the 6 o'clock position.

The stacking table 400 has a first and a second clamping finger 442, 444. In a variant, two clamping fingers are provided on each of two opposite sides. The clamping fingers move in the y-direction perpendicular to the plane of rotation of the pick-ups. These two clamping fingers 442, 444 grip from both (transverse or longitudinal) sides along the x or y direction laterally over the electrode stack formed from the anode and cathode layers AL, KL and come into or out of engagement with the uppermost of the anode and cathode layers AL, KL in a controlled manner, in order to press the uppermost of the anode and cathode layers AL, KL against the electrode stack ES on the layer 420. For this purpose, corresponding linear drives 446, 448 are provided in the z-direction and in the x-direction or y-direction, depending on the arrangement of the clamping fingers 442, 444, which move the first and second clamping fingers 442, 444 relative to the base plate 450 of the stacking table 400 and to its deposit 420 in a controlled manner. In a variant, the stacking table 400 is supported on a rigid plate that has a recess. The base plate 450 can only be moved in the x-direction along two linear guides relative to the rigid plate. There is a Y-plate on the base plate 450, which can be moved in the y-direction relative to the base plate 450. The Y-plate carries an actuator plate. The actuator plate is fitted with the deposit 420. The actuator plate can be rotated around the z-axis together with the deposit 420 and therefore also the clamping fingers and their actuators.

There is an x- or y-actuator for each clamping finger on the actuator plate, depending on the direction of movement and arrangement of the clamping fingers, in order to be able to position an individual clamping finger in the y-direction. The z-actuator of each clamping finger is arranged on a separate plate, which is arranged on the Y-plate and next to the deposit 420. The y-actuator thus moves the separate plate and thus the respective clamping finger 442, 444 together with its z-actuator.

When the Y-plate is displaced in the y-direction, the actuator plate is also displaced in the y-direction together with the clamping fingers. The deposit 420 can be positioned in the z-direction by a z-drive, which can be arranged exactly below the deposit and has room for movement in the x-direction in the recess of the rigid plate.

The first and second layer turners 150, 200 are set up to pick up the individual anode layers AL and the individual cathode layers KL by means of controlled pneumatic under-pressure p−− and to hold them during the turning to the first or the second output order A1, A2. In addition, in the variant of the apparatus 100 shown here, the first and second layer turners 150, 200 are set up to release the individual anode layers AL and the individual cathode layers KL in the first and the second stacking places by means of controlled pneumatic over-pressure p++ in order to stack the layers AL, KL on the deposit 420 to form the electrode stack ES.

For this purpose, it is illustrated in FIG. 2 that the first and second layer turners 150, 200 each have a rotatable over-pressure/under-pressure distribution 650, which is arranged around the inner shaft 160, 210 in order to feed the pick-ups with the controlled pneumatic under-pressure p−− and/or over-pressure p++. Two concentric rings 652, 654 are rotatably provided, surrounding each other in a fluid-tight manner, in which an over-pressure/under-pressure transfer 656 is realized for each of the transducers. A fluid line extends from the over/under pressure transfer 656 for each pick-up 156, 206 into the inner shaft 160, 210 and from there to a connection for a radially flexible line 656 to the respective pick-up 156, 206. The flexible line 656 is connected to a plurality of openings in the surface of the transducers facing away from the center of rotation.

Alternatively, each of these openings is associated with an elastic nozzle which protrudes slightly above the surface of the pick-up (for example less than 3 mm) and is connected to the flexible line 656. This allows the anode layers AL and cathode layers KL to be picked up safely and gently and released with high precision in their alignment on the deposit 420. The positioning device 430 lowers the deposit 420 in a controlled manner during stacking after each depositing of the individual anode layers AL and the individual cathode layers KL by a distance that corresponds to the thickness of a individual anode layer AL or an individual cathode layer KL. This ensures a very short, defined free path between the delivery from the pick-ups 156, 206 and the impact on the electrode stack ES.

The variants of the stacking unit described above, their structural and operational aspects, as well as the variants of the method are merely intended to provide a better understanding of the structure, the mode of operation and the properties; they do not limit the disclosure to the embodiments. The figures are partly schematic. Essential properties and effects are shown, in some cases clearly enlarged, in order to clarify the functions, operating principles, technical embodiments and features. Each mode of operation, each principle, each technical embodiment and each feature disclosed in the Fig. or in the text can be freely and arbitrarily combined with all claims, each feature in the text and in the other Fig., other modes of operation, principles, technical embodiments and features contained in this disclosure or resulting therefrom, so that all conceivable combinations can be assigned to the described procedure. This also includes combinations between all individual embodiments in the text, i.e. in each section of the description, in the claims and also combinations between different variants in the text, in the claims and in the figures. The claims also do not limit the disclosure and thus the possible combinations of all the features shown. All disclosed features are also explicitly disclosed individually and in combination with all other features here.

1. An apparatus for the production of modules or precursors of modules, said apparatus comprising:
a first conveyor is provided and adapted to convey individual anode layers (AL) to a first transfer location for transfer to a first layer turner;
a second conveyor is provided and adapted to convey individual cathode layers to a second transfer location for transfer to a second layer turner;
wherein the first and the second layer turners each have at least one pick-up and a first drive and are provided and adapted to pick up an anode or cathode layer by the pick-ups at the respective first or second transfer locations from the first or second conveyor and rotate the anode or cathode layer by the respective first drive by a respective rotation angle to a respective first or second delivery location;
a stacking table with a drive is provided and adapted to move back and forth between the first and the second delivery location;
wherein the first and the second layer turners are provided and adapted to deliver a respective individual anode or cathode layer from its pick-up to the stacking table at the first and the second delivery location, respectively, when the pick-up is at the first or second delivery location, respectively; and
wherein the first and the second layer turners each have a second drive for the pick-up, which are provided and adapted to radially retract the respective pick-up when the first and the second layer turners approach the pick-up of the other layer turner in a space between the first and second layer turners.

2. The apparatus according to claim 1, wherein
the first and the second layer turners are provided and adapted to move the pick-up by the second drive when the pick-up approaches the respective first or second transfer location and/or the respective first or second delivery location.

3. The apparatus according to claim 1, wherein
the first conveyor and the second conveyor are arranged adjacent to and at a distance from one another;
the first conveyor and/or the second conveyor are designed as belt conveyors which face the first or second layer turners with their respective underside in order to convey the individual anode layers or the individual cathode layers on their underside to the first or second transfer location;
the first conveyor and/or the second conveyor each have a controlled under-pressure/over-pressure conveyor belt, and are provided and adapted to pick up the individual anode layers or the individual cathode layers by controlled pneumatic under-pressure and to hold them during conveying to the first or second transfer location; and/or to deliver the individual anode layers or the individual cathode layers at the first or second transfer location to the first or second layer turners by a controlled pneumatic over-pressure; and/or
the first and/or the second layer turner each has a plurality of pick-ups for picking up the individual anode or cathode layers, to rotate past the respective transfer location and the respective delivery location in a continuous or clocked manner, and in the process to pick up an anode or cathode layer or to deliver an anode or cathode layer.

4. The apparatus according to claim 1, wherein
the first and the second layer turners have a substantially matching structure, matching function and/or matching dimensions; and/or
the first and the second layer turners are provided and adapted to rotate clockwise and anti-clockwise respectively by their respective first drive in such a way that the individual anode or cathode layers move from their transfer location to their delivery location while avoiding a space between the first and the second layer turners.

5. The apparatus according to claim 1, wherein
the first and second transfer locations between the first conveyor and the second conveyor and the first and second layer turners, respectively, each have a first center, and the first and second delivery locations between the first and second layer turners and the stacking table, respectively, each have a second center; and wherein
the first and second centers lie on respective straight lines which at least approximately intersect a respective center of rotation of the first layer turner or of the second layer turner.

6. The apparatus according to claim 1, wherein
the stacking table comprises a deposit for the anode and cathode layers; and/or
the stacking table has an individual-axis or multi-axis positioning device which is provided and adapted to move the deposit along or around the respective anode and cathode layer(s) in order to align them with the first and second delivery locations, respectively; and/or
the stacking table has at least one first and at least one second clamping finger, which are provided and adapted to come into or out of engagement with the respectively uppermost of the anode and cathode layers and/or to press the respectively uppermost of the anode and cathode layers against the electrode stack on the deposit; and/or
the deposit are rotated about a z-axis with the clamping fingers; and/or
the deposit are positioned in the x-and/or y-direction using the clamping fingers.

7. The apparatus according to claim 6, wherein
the first and the second layer turner are provided and are set up to pick up the individual anode layers and the individual cathode layers by means of controlled pneumatic under-pressure and to hold them during the turning to the first and the second delivery location, respectively; and/or by means of a controlled pneumatic over-pressure the individual anode layers and the individual cathode layers are held during the turning to the first and the second delivery location, respectively the second delivery location; and/or by means of a controlled pneumatic over-pressure to deliver the individual anode layers and the individual cathode layers to the first or second delivery location in order to stack the layers on the deposit; and/or
the first and the second layer turners each have a rotatable positive/under-pressure distributor, which is provided and adapted to feed the pick-ups with the controlled pneumatic under-pressure and/or over-pressure; and/or
the first and the second layer turner are provided and adapted to turn only individual ones of the anode layers or only individual ones of the cathode layers towards the first or the second delivery location, respectively.

8. The apparatus according to claim 6, further comprising
an adjusting device configured to lower the deposit during stacking of the individual anode layers and individual cathode layers by a path distance from which substantially corresponds to a thickness of an individual anode layer or an individual cathode layer.

9. The apparatus according to claim 1, wherein
the first drive is a rotary drive which is provided and adapted to turn the pick-up of the respective layer turner; and
the second drive has a rotary drive with an eccentric shaft geared to the pick-up in order to radially retract and/or extend the pick-up of the respective layer turner, or
the second drive has a linear drive which is geared to one of the pick-ups in order to radially retract and/or extend the pick-up of the respective layer turner.

10. A method for the production of modules or precursors of modules comprising:
conveying individual anode layers to a first transfer location for transfer to a first layer turner;
conveying individual cathode layers to a second transfer location for transfer to a second layer turner;
picking up respective individual anode or cathode layers at the respective first or second transfer locations by a corresponding pick-up of a respective first or second layer turners;
turning the picked up individual anode or cathode layers by a respective rotation angle to a respective first or second delivery location;
moving a stacking table with a drive back and forth between the first and the second delivery locations;
delivering the respective individual anode or cathode layer at the first or the second delivery location to the stacking table when the anode or cathode layer is at the first or the second delivery location; and
radially retracting the pick-up of the first and/or second layer turner when the first and/or second layer turner approaches the pick-up of the other layer turner in a space between the first and second layer turners.

11. The apparatus according to claim 1 wherein the modules or precursors of modules are fuel or battery cells containing a layer material.

12. The method according to claim 10 wherein the modules or precursors of modules are fuel or battery cells containing a layer material.
